(19) United States
(12) Patent Application Publication
(10) Pub. No.: US 2021/0289726 A1
(43) Pub. Date: Sep. 23, 2021

(54) HYDROPONIC PLANT GROWTH SYSTEM

(71) Applicant: Just Vertical Incorporated, Brampton (CA)

(72) Inventors: Conner Thomas Shaw Tidd, Toronto (CA); Kevin Jakiela, Kitchener (CA); Thomas Wong, Brampton (CA); Randy Yang, North York (CA); Kamil Musielak, Mississauga (CA)

(21) Appl. No.: 16/826,468

(22) Filed: Mar. 23, 2020

(51) Int. Cl. A01G 31/06; A01G 7/04

(52) U.S. Cl. CPC A01G 31/06; A01G 2031/006; A01G 7/045

(57) ABSTRACT

A hydroponic plant growth system including an upwardly extending housing having a cavity therein defining a liquid nutrient flow column and a plurality of growth pod ports each extending from a respective port opening at an outer surface of a front wall of the housing to the cavity. Each growth pod port sized to receive a growth pod. Wherein when a growth pod is mounted in a respective one of the growth pod ports, a mounting flange of the growth pod abuts the outer surface the front wall and a growth pod axis of the growth pod extends downwardly from a respective growth pod proximal end through the growth pod port at an angle of between 30 degrees and 60 degrees to the growth pod port axis.

### FIELD

The specification relates generally to hydroponic plant growth systems, and more specifically, to vertical hydroponic plant growth systems.

### BACKGROUND

Hydroponics is a method of growing plants, both indoors and outdoors, without soil, and instead, using mineral nutrient solutions in a water solvent (i.e., liquid nutrients). Hydroponic systems are seen as a convenient and healthy way for individual users to grow edible plants in their homes.

### SUMMARY

The following summary is intended to introduce the reader to various aspects of the applicant's teaching, but not to define any invention.

According to some aspects, a hydroponic plant growth system includes an upwardly extending housing having a front wall and a back wall. The housing having a cavity extending along a housing axis between the front wall and the back wall. The cavity defining a liquid nutrient flow column. The hydroponic plant growth system further includes a plurality of growth pod ports each extending from a respective port opening at an outer surface of the front wall to the cavity along a respective growth pod port axis. The hydroponic plant growth system further includes a plurality of growth pods, each growth pod including a growing medium carrier having a carrier sidewall extending from a carrier proximal end to a carrier distal end along a carrier axis. The carrier sidewall defining an inner carrier chamber extending from a proximal end opening at the carrier proximal end towards the carrier distal end. The carrier sidewall having at least one liquid nutrient aperture to the chamber between the carrier proximal and distal ends. Each growth pod further including a mounting flange connected to the carrier proximal end. Each growth pod port sized to receive a respective growth pod of the plurality of growth pods. When the respective growth pod is mounted in a respective one of the growth pod ports, the mounting flange of the respective growth pod abuts the outer surface the front wall and the growth pod axis of the respective growth pod extends downwardly from the respective growth pod proximal end through the respective growth pod port at an angle of between 30 degrees and 60 degrees to the growth pod port axis.

In some examples, each growth pod of the plurality of growth pods includes a mounting tab secured to the mounting flange and each of the plurality of growth pod ports include a mounting tab recess positioned to receive a respective mounting tab. When a respective growth pod is mounted in a respective growth pod port, the mounting tab of the respective growth pod is secured in the mounting tab recess of the respective growth pod port.

In some examples, when each growth pod is mounted in a respective one of the growth pod ports, at least 70 percent of the carrier sidewall by length along the carrier axis extends within the liquid nutrient flow column.

In some examples, the port openings of each growth pod port are coplanar.

In some examples, the port openings of each growth pod port are vertically aligned.

In some examples, a portion of the front wall that extends between adjacent growth pod ports is coplanar with each of the adjacent growth pod ports.

In some examples, the outer surface of the front wall and the plurality of growth pod ports are coplanar.

In some examples, the hydroponic plant growth system further includes a liquid nutrient delivery system for supplying a stream of liquid nutrients to the liquid nutrient flow column.

In some examples, the liquid nutrient delivery system includes a supply conduit having an outlet proximate an upper end of the liquid nutrient flow column.

In some examples, the hydroponic plant growth system further includes a liquid nutrient catch basin below the liquid nutrient flow column.

In some examples, the hydroponic plant growth system further includes a liquid nutrient return conduit extending between the liquid nutrient flow column and the liquid nutrient catch basin.

In some examples, the hydroponic plant growth system further includes a pump to move liquid nutrients from the liquid nutrient catch basin to the liquid nutrient source.

In some examples, the hydroponic plant growth system further includes a second upwardly extending housing spaced apart from the housing, the second housing having a second housing front wall and a second housing back wall. The second housing having a second housing cavity extending along a second housing axis between the second housing front wall and the second housing back wall. The second housing cavity defining a second housing liquid nutrient flow column. The second housing further having a second plurality of growth pod ports each extending from a respective port opening at an outer surface of the second housing front wall to the second housing cavity. Each growth pod port sized to receive a growth pod of the plurality of growth pods.

In some examples, a plane defined by the front wall of the housing is nonparallel to a second plane defined by the second housing front wall.

In some examples, each growth pod port of the housing is horizontally aligned with one growth pod port of the second plurality of growth pod ports of the second housing.

In some examples, the hydroponic plant growth system further includes a light source intermediate the front wall of the housing and the front wall of the second housing.

In some examples, the hydroponic plant growth system further includes a second liquid nutrient supply conduit for supplying a stream of liquid nutrient to the second liquid nutrient flow column.

In some examples, the pump moves liquid nutrient from the liquid nutrient catch basin to the second liquid nutrient source.

According to some aspects, a growth pod for use in a hydroponic plant growth system includes a growing medium carrier having a carrier sidewall extending from a carrier proximal end to a carrier distal end along a carrier axis. The carrier sidewall defining an inner carrier chamber extending from a proximal end opening at the carrier proximal end towards the carrier distal end. The carrier sidewall having at least one liquid nutrient aperture to the chamber between the carrier proximal and distal ends. The growth pod further including a mounting flange connected to the carrier proximal end. The mounting flange having a distal flange surface that lies on a mounting plane. The mounting plane oriented at an angle of between 30 degrees and 60 degrees to the carrier axis.

In some examples, the growth pod further includes a mounting tab secured to the distal flange surface adjacent the carrier sidewall.

In some examples, the mounting tab extends perpendicular to the mounting flange.

In some examples, a transverse width of the inner carrier chamber tapers along the carrier axis toward the carrier distal end.

In some examples, each liquid nutrient aperture of the at least one liquid nutrient aperture is oblong in shape and extends from the carrier distal end toward the carrier proximal end.

In some examples, each liquid nutrient aperture of the at least one liquid nutrient aperture has a length that is at least 40% of an average length of the growing medium carrier measured along the carrier axis.

In some examples, the growth pod further includes a removable humidity dome securable to the growing medium carrier.

In some examples, the growth pod further includes a seed pod within the inner carrier chamber.

In some examples, the seed pod comprises peat moss and at least one plant seed.

### BRIEF DESCRIPTION OF THE DRAWINGS

The drawings included herewith are for illustrating various examples of apparatuses of the present specification and are not intended to limit the scope of what is taught in any way. In the drawings:

FIG. 1 is a perspective view of an example hydroponic plant growth system;

FIG. 2 is a perspective view of the hydroponic plant growth system of FIG. 1, shown with growth pods inserted into the growth pod ports;

FIG. 3 is a cross sectional view of the hydroponic plant growth system of FIG. 2, taken along line 3-3;

FIG. 4 is a cross sectional view of the hydroponic plant growth system of FIG. 2, taken along line 4-4;

FIG. 5 is a perspective view of an example growth pod;

FIG. 6 is a side view of the growth pod of FIG. 5;

FIG. 7 is a side view of the growth pod of FIG. 5, shown with a humidity dome connected to the growth pod;

FIG. 8 is a side view of another example growth pod; and

FIG. 9 is a perspective view of the hydroponic plant growth system of FIG. 1, shown with an alternative example of a growth pod port.

### DESCRIPTION OF EXEMPLARY EMBODIMENTS

Various apparatuses will be described below to provide an example of an embodiment of each claimed invention. No embodiment described below limits any claimed invention and any claimed invention may cover apparatuses that differ from those described below. The claimed inventions are not limited to apparatuses having all of the features of any one apparatus described below or to features common to multiple or all of the apparatuses described below. It is possible that an apparatus described below is not an embodiment of any claimed invention. Any invention disclosed in an apparatus described below that is not claimed in this document may be the subject matter of another protective instrument, for example, a continuing patent application, and the applicants, inventors, or owners do not intend to abandon, disclaim, or dedicate to the public any such invention by its disclosure in this document.

Hydroponics is a method of growing plants, both indoors and outdoors, without soil, and instead, using mineral nutrient solutions in a water solvent (i.e., liquid nutrients). When hydroponically growing plants, it may be space efficient and therefore desirable to house plants in a vertical orientation. When hydroponically growing plants in a vertical orientation, the design of the hydroponic system itself can affect a plant's ability to grow. For example, the design of the system will determine how much liquid nutrient and how much light a plant receives. The applicant has found that current vertical hydroponic systems do not maximize the amount of liquid nutrients and light that a plant receives.

The present application discloses aspects relating to hydroponic plant growth systems. The hydroponic plant growth systems described may improve liquid nutrient and light delivery, while allowing for simple exchange and/or replanting of growth pods.

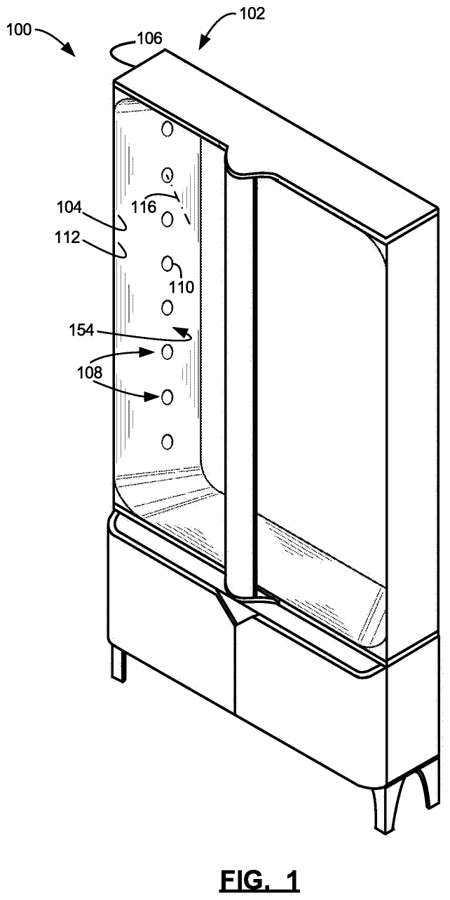

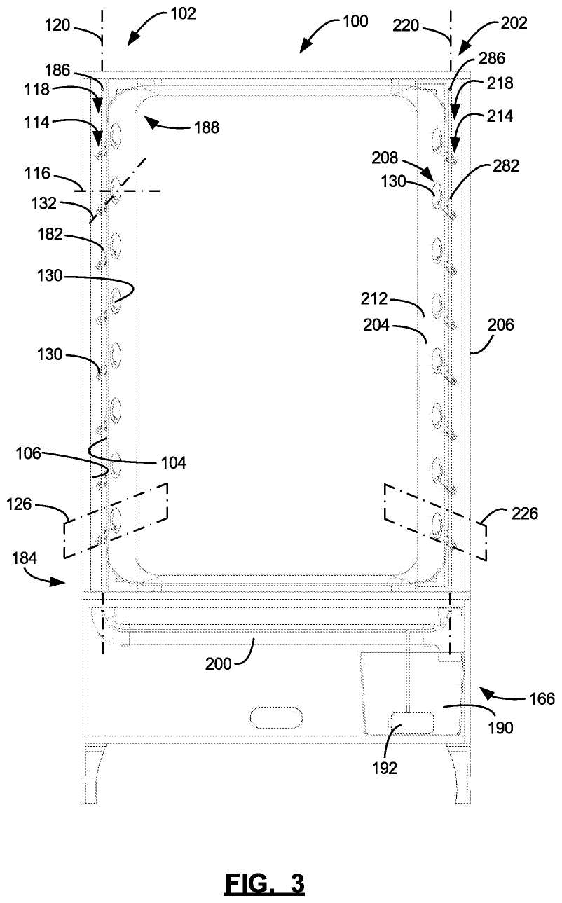

Referring to FIG. 1, an example hydroponic plant growth system 100 is illustrated. In the example illustrated, the hydroponic plant growth system 100 includes an upwardly extending housing 102. As shown, the housing 102 includes a front wall 104, a back wall 106, and a plurality of growth pod ports 108. Each growth pod port 108 may extend from a respective port opening 110 at an outer surface 112 of the front wall 104 to a liquid nutrient flow column 114 (see FIG. 3). For example, each growth pod port 108 may extend along a respective growth pod port axis 116. As shown, each growth pod port 108 may be sized to receive a growth pod 130.

Referring to FIG. 3, in the example illustrated, the liquid nutrient flow column 114 is defined by a cavity 118 that extends between the front wall 104 and the back wall 106. As shown, cavity 118 may extend along a housing axis 120.

Still referring to FIG. 3, in the example illustrated, when a growth pod 130 is mounted in a respective one of the growth pod ports 108, the growth pod 130 extends downwardly, along a carrier axis 132, through the growth pod port 108. As shown, the growth pod 130 may extend downwardly when mounted in a respective one of the growth pod ports 108 so that a seed pod (not shown) within the growth pod 130 may be housed in the growth pod with little risk of falling out. That being said, the downward angle should not be so great that too much light is prevented from reaching a seed pod within the growth pod 130. Accordingly, in some embodiments, the growth pods 130 may extend downwardly at an angle between 30 degrees and 60 degrees to the growth pod port axis 116. In the example illustrated, the growth pods 130 are shown to extend downwardly at an angle of approximately 50 degrees to the growth pod port axis 116.

Referring now to FIG. 5, shown therein is an example growth pod 130. In the example illustrated, the growth pod 130 includes a growing medium carrier 134. The growing medium carrier 134 includes a carrier sidewall 136. In the example illustrated, the carrier sidewall 136 extends from a carrier proximal end 138 to a carrier distal end 140 along the carrier axis 132. As shown, the carrier sidewall 136 may define an inner carrier chamber 142 that extends from a proximal end opening 144 towards the carrier distal end 140. The inner carrier chamber 142 may be sized to hold a seed pod (not shown). As an example, the seed pod may include a growing medium and a plant seed. In some examples, the growing medium is for supporting the plant seed within the inner carrier chamber 142 while allowing the plant seed to be exposed to liquid nutrients and light. In some examples, the growing medium is at least one of perlite, gravel, and peat moss.

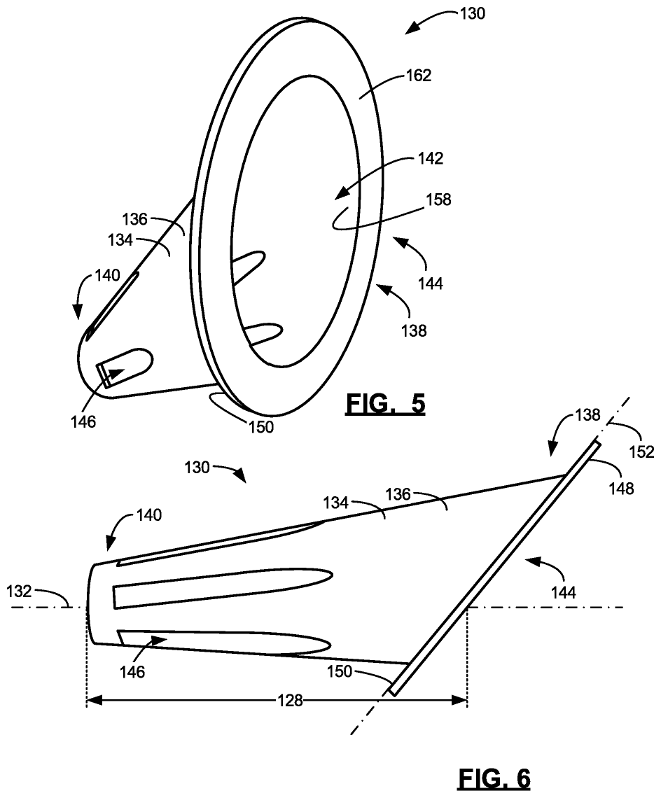

Referring to FIG. 6, in the example illustrated, the inner carrier chamber 142 is tapered. Specifically, the illustrated example shows an inner carrier chamber 142 tapered along the carrier axis 132 toward the carrier distal end 140. An inner carrier chamber 142 that is tapered may promote retention of a seed pod within the inner carrier chamber 142. This may mitigate the seed pod from falling out of the inner carrier chamber 142 when a plant has grown to maturity and a majority of the plant (and its weight) is located outside of growth pod 130 (i.e. proximally of proximal end opening 144). In some embodiments, at least 75% of an axial length of the carrier sidewall 136 (measured along carrier axis 132) is tapered towards carrier distal end 140 (i.e. has a width transverse to carrier axis 132 that decreases towards carrier distal end 140). In the example shown, the entire axial length of carrier sidewall 136 is tapered towards carrier distal end 140.

Still referring to FIG. 5, in the example illustrated, the carrier sidewall 136 of the growth pod 130 includes at least one liquid nutrient aperture 146. The liquid nutrient apertures 146 allow for liquid nutrients to flow into and out of the inner carrier chamber 142 when the growth pod 130 is received by a respective growth pod port 108. The liquid nutrient apertures 146 also allow roots of a plant growing within the inner carrier chamber 142 to extend out from the inner carrier chamber 142. Optionally, for similar purposes, the carrier distal end 140 may include an aperture (not shown) to the inner carrier chamber 142.

In the example illustrated, each liquid nutrient aperture 146 extends through the carrier sidewall 136 of the growth pod 130 to the inner carrier chamber 142, between the carrier proximal and distal ends 138, 140. In some embodiments, the liquid nutrient apertures 146 may be oblong in shape and may extend from the carrier distal end 140 toward the carrier proximal end 138. As shown, each liquid nutrient aperture 146 is at least 40 percent of an average length of the growing medium carrier 134, i.e., the length 128 of the growing medium carrier 134 along the carrier axis 132 when viewed from the side. In other examples, the liquid nutrient apertures may include a pattern of smaller apertures (e.g. a mesh-like pattern).

Referring to FIG. 6, in the example illustrated, the growth pod 130 includes a mounting flange 148 at the carrier proximal end 138. As shown, the mounting flange 148 may include a distal flange surface 150 that lies on a mounting plane 152. In some embodiments, the mounting plane 152 may be oriented between 30 degrees and 60 degrees to the carrier axis 132. For example, the mounting plane 152 may be oriented at an angle of approximately 50 degrees to the carrier axis, as shown.

Referring to FIG. 3, in the example illustrated, when a growth pod 130 is mounted in a respective one of the growth pod ports 108 the mounting flange 148, specifically the distal flange surface 150, abuts the outer surface 112 the front wall 104. As illustrated in FIG. 3, when the mounting flange 148 abuts the outer surface 112 of the front wall 104, the housing 102 and the growth pods 130 together form a relatively flat and low profile assembly. A relatively planer outer surface 112 of the front wall 104, as well as growth pods 130 that do not substantially extend beyond the outer surface 112 of the front wall 104 when received in a growth pod port 108, may allow for light to be transmitted to each growth pod 130 without interference from adjacent growth pods 130, growth pod ports 108, and/or portions 154 of the outer surface 112. In other hydroponic systems, it has been found that growth pods that extend substantially beyond the face of the system can shade adjacent growth pods, and therefore inhibit the growth of seeds/plants therein.

In some examples of the hydroponic plant growth system 100 (not shown), the growth pod ports may include a shoulder set in from the outer surface of the front wall. In this example, a growth pod 130 can be received by the growth pod port such that a front face 162 of the growth pod 130 may sit flush with the outer surface 112 of the front wall 104. However, in a preferred embodiment, the mounting flange 148 abuts the outer surface 112 of the front wall 104 so that the mounting flange 148 can act as a grip for a user when removing the growth pod 130 from the respective growth pod port 108.

Referring to FIG. 1, in the example illustrated, a portion 154 of the front wall 104 that extends between adjacent growth pod ports 108 is coplanar with each of the adjacent growth pod ports 108. In some examples, as shown, the outer surface 112 of the front wall 104 and the plurality of growth pod ports 108 may be coplanar.

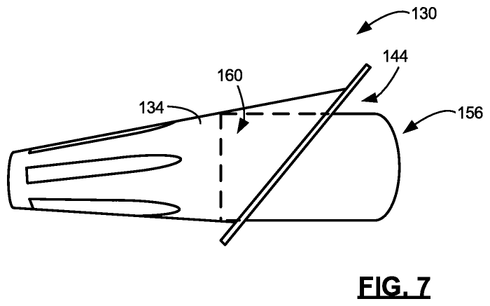

Referring to FIG. 7, in the example illustrated, the growth pod 130 is shown with a removable humidity dome 156 that extends outwardly from the proximal end opening 144. When in use, the humidity dome 156 helps to trap humidity within the inner carrier chamber 142, which can aid in germination of a seed pod within the inner carrier chamber 142. The humidity dome 156 may be connected to growth pod 130 in any suitable manner. In the example illustrated, the humidity dome 156 is frictionally connected to an inner surface 158 of the growing medium carrier 134. In some examples (not shown), the inner surface 158 of the growing medium carrier and a distal end 160 of the removable humidity dome 156 can each be threaded to facilitate attachment of the humidity dome 156 to the growing medium carrier 134.

In the example illustrated, the humidity dome 156 is transparent, to allow light to enter the inner carrier chamber 142 and to not shade adjacent growth pods 130.

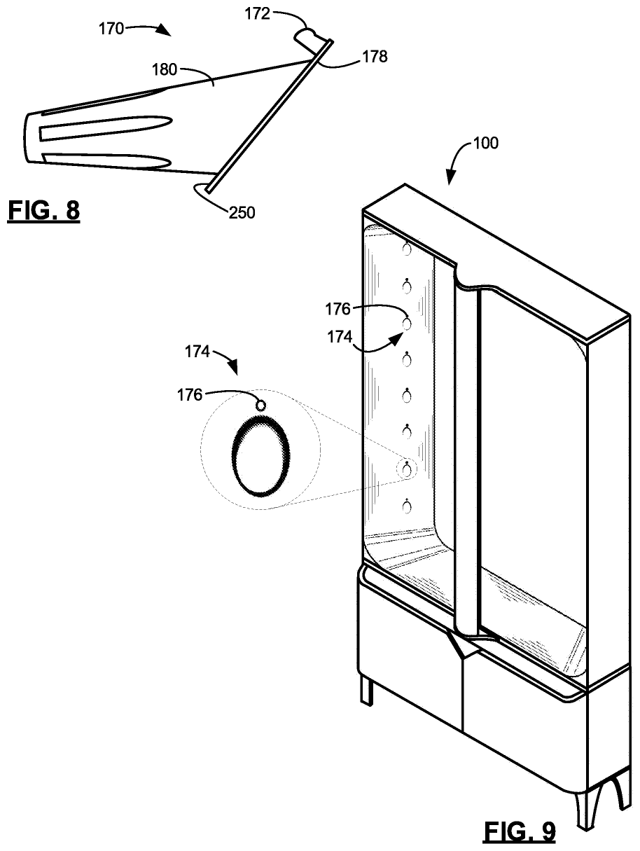

Referring to FIG. 8, shown therein is an alternative example of a growth pod 170 that includes a mounting tab 172 and referring to FIG. 9, shown therein is a hydroponic plant growth system 100 with an alternative example of a growth pod port 174 that includes a corresponding mounting tab recess 176. In the example illustrated, when the growth pod 170 is received by the growth pod port 174, the mounting tab 172 is received by the mounting tab recess 176. When received by the mounting tab recess 176, the mounting tab 172 may secure the growth pod 170 in the growth pod port 174. This may reduce the likeliness of a growth pod 170 unintentionally being dislodged from a respective growth pod port 174. For example, as described above, as a plant grows to maturity more of the plant (and its weight) moves outside of the growth pod 170. This weight can create a moment on the growth pod 170, which may cause the growth pod 170 to dislodge from its respective growth pod port 174. A growth pod 170 having mounting tab 172 received by a mounting tab recess 176 may stop such a dislodging from occurring.

Referring to FIG. 8, in the example illustrated, the mounting tab 172 extends distally from a mounting flange 178 of the growth pod 170 adjacent to a carrier sidewall 180 of the growth pod 170. For example, mounting tab 172 may extend distally from a distal flange surface 250 of mounting flange 178. As shown, the mounting tab 172 may extend perpendicular to the mounting flange 178.

Referring now to FIG. 3, in the example illustrated, the hydroponic plant growth system 100 includes a liquid nutrient delivery system 166 for supplying a stream of liquid nutrients to the liquid nutrient flow column 114. In the example illustrated, the liquid nutrient delivery system 166 includes a supply conduit 182, a pump 192, a return conduit 200, and a basin 190. As shown, the supply conduit 182 may include a nutrient delivery outlet 186 proximate an upper end 188 of the liquid nutrient flow column 114. Due to gravity, a stream of liquid nutrients may flow from the nutrient delivery outlet 186 downwardly through the liquid nutrient flow column 114, over at least a portion of the growth pods 130 that extend into the liquid nutrient flow column 114.

Still referring to FIG. 3, in the example illustrated, the return conduit 200 is positioned at a lower end 184 of the flow column 114. The return conduit 200 may collect liquid nutrients that were not absorbed within the liquid nutrient flow column 114 by, for example, a seed pod. As shown, the return conduit 200 can direct liquid nutrients to the liquid nutrient catch basin 190.

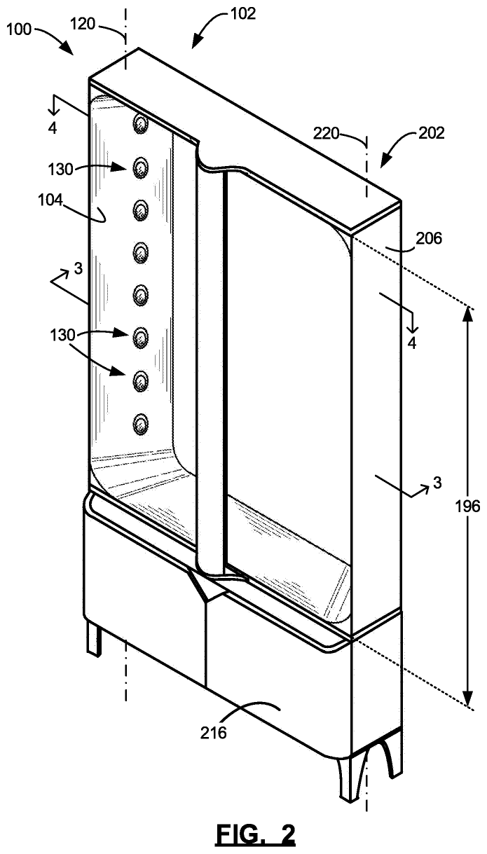

In the example illustrated, the hydroponic plant growth system includes a pump 192 to move liquid nutrients from the liquid nutrient catch basin 190, through the supply conduit 182, to the nutrient delivery outlet 186. As shown, the liquid nutrient catch basin 190 may be accessible by a user of the system 100 to add additional liquid nutrients to system 100 when needed. In some embodiments, referring for example to FIG. 2, the catch basin 190 may be located behind an openable door 216, and a user may add additional liquid nutrients to the system 100 by accessing the catch basin 190 through the openable door 216.

In some embodiments, there may be one or more liquid nutrient delivery outlets 186 for supplying liquid nutrients to the plurality of growth pods 130. As shown in FIG. 3, a single liquid nutrient delivery outlet 186 may be provided in the liquid nutrient flow column 114. A single liquid nutrient delivery outlet 186 can supply liquid nutrients to each growth pod 130 when the growth pod ports and the liquid nutrient delivery outlet 186 are vertically aligned, as shown. This arrangement may allow for liquid nutrients to flow from the nutrient delivery outlet 186 to a first growth pod 130 (when received by a growth pod port 108), and to cascade from the first growth pod 130 to a second growth pod 130 located below. In some examples, the growth pod ports 108 may be vertically aligned. For example, the grown pod ports 108 may be co-planar. In examples where the growth pod ports 108 are co-planer, each growth pod 130 (granted they are the same size) may extend within the liquid nutrient flow column 114 an equal distance. This may increase the amount of liquid nutrients that cascade from a first growth pod to a second growth pod located below.

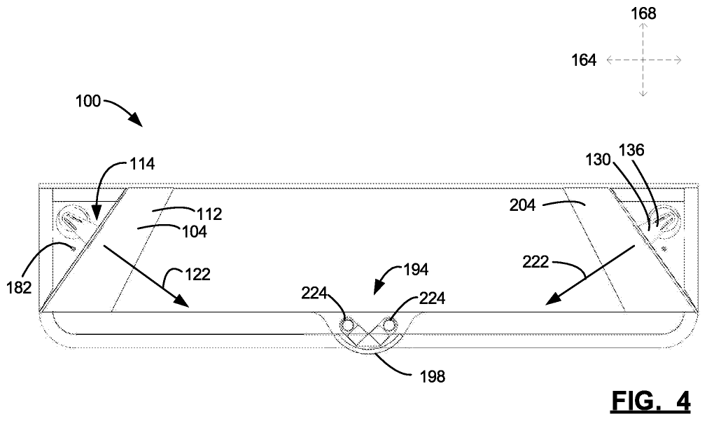

Referring to FIG. 4, in some examples, at least 70 percent of the carrier sidewall 136 by length along the carrier axis extends within the liquid nutrient flow column 114. When a large portion of the carrier sidewall 136 extends within the liquid nutrient flow column 114, the likelihood of the carrier sidewall 136 being exposed to the liquid nutrients flowing through the flow column 114 may be increased, which may encourage proper nutrition and plant growth.

Referring to FIG. 3, in some examples, the hydroponic plant growth system 100 may include a second upwardly extending housing 202 spaced apart from the first housing 102. A second housing 202 may allow a user of the system 100 to grow more plants at one time without requiring that user to have two of certain components, for example, the pump 192, a light, and the catch basin 190. In the example illustrated, the second upwardly extending housing 202 has similar characteristics to the first housing 102. For example, the second housing 202 includes a second housing front wall 204, a second housing back wall 206, and a second housing cavity 218 extending along a second housing axis 220 between the second housing front and back walls 204, 206. In some examples, the second housing cavity 218 defines a second housing liquid nutrient flow column 214.

Referring to FIG. 3, in the example illustrated, the second housing 202 includes a second plurality of growth pod ports 208. The second plurality of growth pod ports 208 may each extend from a respective port opening 210 at an outer surface 212 of the second housing front wall 204 to the second housing cavity 218. As shown, the second plurality of growth pod ports 208 may be sized to receive a growth pod 130 of the plurality of growth pods 130.

Referring to FIG. 4, in the example illustrated, the hydroponic plant growth system 100 includes a light source 194. As shown, the light source may include one or more LED tube lights 224. In some examples, the light source 194 may be laterally positioned intermediate both the front wall 104 of the first housing 102 and the front wall 204 of the second housing 202. Referring to FIG. 1, in the example illustrated, the light source 194 extends along the entire height 196 of the front walls 104, 204. In other examples, the light source 194 may only extend partially along the height 196 of the front walls 104, 204. In yet another example, more than one light source may be used to provide light to the seed pods within the growth pods 130. Referring to FIG. 4, as shown, the hydroponic plant growth system 100 may include a shade 198 to reduce the amount of light that emits outward from the system, i.e., shade 198 may reduce light pollution into the surrounding environment. In some examples, the shade 198 may be a reflective shade to direct light emitted from the light source 194 toward the growth pods 130.

Referring to FIG. 3, the housing 202 may have any suitable position and rotational orientation relative to the first housing 102. For example, the housing 202 may be positioned and rotationally oriented to permit a central light source 194 (see FIG. 1) to provide lighting to growth pods 130 in both housings 102, 202. Referring to FIG. 4, as shown, front walls 104, 204 may not be parallel to one-another. Instead, each front wall 104, 204 may be oriented to have a facing direction 122, 222 that is at a (non-zero) angle to transverse axis 164 and forward axis 168. Referring to FIG. 3, as shown, a plane 126 defined by the front wall 104 of the first housing 102 may be nonparallel to a plane 226 defined by the front wall 204 of the second housing 202 and both planes 126, 226 may be oriented to face forwardly. This arrangement may also permit a user to better monitor and access growth pods 130, 230 and the plants growing from them.

Referring to FIG. 3, in the example illustrated, the liquid nutrient delivery system 166 further includes a second liquid nutrient supply conduit 282 having a delivery outlet 286 for supplying a stream of liquid nutrients to the second liquid nutrient flow column 214. As shown, the supply conduit 282 may be connected to the pump 192 for receiving liquid nutrients from the basin 190. In the example illustrated, the second liquid nutrient flow column 214 is fluidly connected to the liquid nutrient catch basin 190 by the return conduit 200 so that liquid nutrients not absorbed in the second liquid nutrient flow column 214 flow to the liquid nutrient catch basin 190.

In alternative embodiments, the liquid nutrient delivery system for supplying liquid nutrients to the first housing is completely separate from the liquid nutrient delivery system for supplying liquid nutrients to the second housing. It may be desirable to have separate systems for each housing as this may allow a user to supply one type of liquid nutrient to the first housing and a second type of liquid nutrient to the second housing.

In some embodiments of the system 100, the first housing 102 and the second housing 202 may have the same number of growth pod ports 108, 208. In other embodiments, the first housing 102 and the second housing 202 may have a different number of growth pod ports 108, 208. Further, the arrangement of the growth pod ports 108, 208 in first and second housings 102, 202, respectively, may be the same or different. For example, in some embodiments, there may be eight growth pod ports 108 evenly spaced apart in the first housing 102, and there may be five growth pod ports 208 in the second housing 204 and the spacing between adjacent growth pod ports 208 may decrease toward the top of the housing 204. It may be desirable to have varying spacing between adjacent growth pod ports so that the use of space can be optimized for plants of different sizes. The space between growth pod ports may affect the type of plants that can be grown therein because the growth pod ports 108, 208 should be separated such that adjacent plants do not overly shade one another. In the example illustrated, each growth pod port 108 of the first housing 102 is horizontally aligned with one growth pod port 208 of the second plurality of growth pod ports 208 of the second housing 202. In the example shown, the spacing between adjacent growth pod ports has been selected to accommodate a wide variety of plant types. In some examples, when in use, an adjacent growth pod port can be left empty to allow a large plant to grow past and shade that growth pod port.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

We claim:

1. A hydroponic plant growth system, comprising:
an upwardly extending housing having a front wall and a back wall, the housing having a cavity extending along a housing axis between the front wall and the back wall, the cavity defining a liquid nutrient flow column;
a plurality of growth pod ports each extending from a respective port opening at an outer surface of the front wall to the cavity along a respective growth pod port axis,
a plurality of growth pods, each growth pod comprising:
a growing medium carrier having a carrier sidewall extending from a carrier proximal end to a carrier distal end along a carrier axis;
the carrier sidewall defining an inner carrier chamber extending from a proximal end opening at the carrier proximal end towards the carrier distal end;
the carrier sidewall having at least one liquid nutrient aperture to the chamber between the carrier proximal and distal ends; and
a mounting flange connected to the carrier proximal end,
each growth pod port sized to receive a respective growth pod of the plurality of growth pods, wherein when the respective growth pod is mounted in a respective one of the growth pod ports, the mounting flange of the respective growth pod abuts the outer surface the front wall and the growth pod axis of the respective growth pod extends downwardly from the respective growth pod proximal end through the respective growth pod port at an angle of between 30 degrees and 60 degrees to the growth pod port axis.

2. The hydroponic plant growth system of claim 1, wherein:
each growth pod of the plurality of growth pods further comprises a mounting tab secured to the mounting flange,
each of the plurality of growth pod ports further comprises a mounting tab recess positioned to receive a respective mounting tab, and
when a respective growth pod is mounted in a respective growth pod port, the mounting tab of the respective growth pod is secured in the mounting tab recess of the respective growth pod port.

3. The hydroponic plant growth system of claim 1, wherein when each growth pod is mounted in a respective one of the growth pod ports, at least 70 percent of the carrier sidewall by length along the carrier axis extends within the liquid nutrient flow column.

4. The hydroponic plant growth system of claim 3, wherein the port openings of each growth pod port are coplanar.

5. The hydroponic plant growth system of claim 4, wherein the port openings of each growth pod port are vertically aligned.

6. The hydroponic plant growth system of claim 5, wherein a portion of the front wall that extends between adjacent growth pod ports is coplanar with each of the adjacent growth pod ports.

7. The hydroponic plant growth system of claim 6, wherein the outer surface of the front wall and the plurality of growth pod ports are coplanar.

8. The hydroponic plant growth system of claim 7, further comprising a liquid nutrient delivery system for supplying a stream of liquid nutrients to the liquid nutrient flow column.

9. The hydroponic plant growth system of claim 8, wherein the liquid nutrient delivery system comprises:
a supply conduit having an outlet proximate an upper end of the liquid nutrient flow column;
a liquid nutrient catch basin below the liquid nutrient flow column;
a liquid nutrient return conduit extending between the liquid nutrient flow column and the liquid nutrient catch basin; and
a pump to move liquid nutrients from the liquid nutrient catch basin to the liquid nutrient source.

10. The hydroponic plant growth system of claim 9, further comprising a second upwardly extending housing spaced apart from the housing, the second housing having:
a second housing front wall and a second housing back wall, the second housing having a second housing cavity extending along a second housing axis between the second housing front wall and the second housing back wall, the second housing cavity defining a second housing liquid nutrient flow column; and
a second plurality of growth pod ports each extending from a respective port opening at an outer surface of the second housing front wall to the second housing cavity, each growth pod port sized to receive a growth pod of the plurality of growth pods.

11. The hydroponic plant growth system of claim 10, wherein a plane defined by the front wall of the housing is nonparallel to a second plane defined by the second housing front wall.

12. The hydroponic plant growth system of claim 11, wherein each growth pod port of the housing is horizontally aligned with one growth pod port of the second plurality of growth pod ports of the second housing.

13. The hydroponic plant growth system of claim 11, further comprising a light source intermediate the front wall of the housing and the front wall of the second housing.

14. The hydroponic plant growth system of claim 10, further comprising a second liquid nutrient supply conduit for supplying a stream of liquid nutrient to the second liquid nutrient flow column, wherein the pump moves liquid nutrient from the liquid nutrient catch basin to the second liquid nutrient source.

15. A growth pod for use in a hydroponic plant growth system, comprising:
a growing medium carrier having a carrier sidewall extending from a carrier proximal end to a carrier distal end along a carrier axis,
the carrier sidewall defining an inner carrier chamber extending from a proximal end opening at the carrier proximal end towards the carrier distal end,
the carrier sidewall having at least one liquid nutrient aperture to the chamber between the carrier proximal and distal ends; and
a mounting flange connected to the carrier proximal end,
the mounting flange having a distal flange surface that lies on a mounting plane, the mounting plane oriented at an angle of between 30 degrees and 60 degrees to the carrier axis.

16. The growth pod of claim 15, further comprising a mounting tab secured to the distal flange surface adjacent the carrier sidewall.

17. The growth pod of claim 16, wherein a transverse width of the inner carrier chamber tapers along the carrier axis toward the carrier distal end.

18. The growth pod of claim 17, wherein each liquid nutrient aperture of the at least one liquid nutrient aperture is oblong in shape and extends from the carrier distal end toward the carrier proximal end.

19. The growth pod of claim 18, wherein each liquid nutrient aperture of the at least one liquid nutrient aperture has a length that is at least 40% of an average length of the growing medium carrier measured along the carrier axis.

20. The growth pod of claim 15, further comprising a removable humidity dome securable to the growing medium carrier.
